(19) United States
(12) Patent Application Publication
(10) Pub. No.: US 2008/0141382 A1
(43) Pub. Date: Jun. 12, 2008

(54) ANTI-TAMPER DEVICE

(75) Inventor: Brian D. JONAS, Troy, NY (US)

Correspondence Address: GREENBLUM & BERNSTEIN, P.L.C., 1950 ROLAND CLARKE PLACE, RESTON, VA, 20191, US

(73) Assignee: LOCKHEED MARTIN CORPORATION, Bethesda, MD (US)

(21) Appl. No.: 11/609,756

(22) Filed: Dec. 12, 2006

(51) Int. Cl. G08B 29/00

(52) U.S. Cl. 726/34

(57) ABSTRACT

A device comprises a modular component configured to be compatible with an existing system. At least one countermeasure component is associated with the modular component and is configured to disable a component of the existing system.

### BACKGROUND OF THE INVENTION

1. Field of the Invention

The present invention relates to a system and method of disabling electronic components and, more particularly to a system and method of neutralizing electronic and/or software related components of an existing system, for example.

2. Background Description

Anti-tamper devices provide an important layer of protection or barrier against unlawful or nefarious activities. In one type of application, by way of example, an anti-tamper device is designed to protect electronic or software components from being reverse engineered or stolen by unauthorized persons or governments. These electronic or software components may be related to military or other government applications such as, for example, highly sensitive aviation instrumentations having sensitive computer and software components.

In an ideal situation, a specification outlining certain system requirements including the integration of an anti-tamper device would be provided to a contractor. The system requirements may include requirements for the design and implementation of an anti-tamper device for a specific component or system. In this manner, the design criteria of a specific component or system would be provided to the system engineer or designer at the beginning stages of the design process. This allows the system engineer or designer to design, engineer and integrate the anti-tamper device with the component or system.

By fully integrating the anti-tamper device with the designed component or system, it is possible to ensure that the anti-tamper device will work in its intended manner. For example, for software components, the designer can ensure that software code is compatible with the anti-tamper device, from a systems integration standpoint. In another example, using a hardware component, the designer can engineer the system to disable the hardware in an efficient and time sensitive manner. That is, a system designer or engineer, at the beginning of the design phase, can design the particular electronic device, for example, with an integrated anti-tamper device.

However, there are many instances, specifically in military applications, when the requirements for an anti-tampering device are not provided to the contractor until after the electronic device has been designed and engineered. Thus, in order to incorporate the anti-tamper device in an already existing system, it is necessary to redesign the entire existing system, from the ground up. Thus, as can be seen, these late arriving anti-tampering requirements add consider cost to the overall design of the system. In fact, in time sensitive situations, the late arriving requirements may even delay the delivery of the requested system. In critical systems, this may be unacceptable.

Accordingly, there is a need to overcome one or more of the above shortcomings.

### SUMMARY OF THE INVENTION

In a first aspect of the invention, a device comprises a modular component configured to be compatible with an existing system. At least one countermeasure component is associated with the modular component and is configured to disable a component of the existing system.

In embodiments, the at least one countermeasure component includes an electrostatic discharge device (ESD), electromagnetic pulse device (EMP), a chemical device, a physical device and/or software code. The software code may be encrypted. The software code can disarm the at least one countermeasure component or disable a software component or hardware component of the existing system. The chemical device is an expandable powdered chemical.

An actuating device is configured to move along an X-Y coordinate system of the modular component. The actuating device is programmable. The actuating device includes a screw type device, rack and pinion gear, and/or magnetic component to move the actuating device along the X-Y coordinate system. The at least one countermeasure component is provided on the actuating device.

The device further includes a detection system. The detection system is at least one of an X-ray sensor, UV sensor, mechanical switch and accelerometer. The detection system may also be a light sensor, infrared sensor and/or microwave sensor. A wireless device receives and/or transmits data signals to and from the device. The modular device is a VME card, daughter card, power PCI (Peripheral Component Interconnect) and/or PCI. The modular component can also be a plug and play device. The at least one countermeasure component is configured to render a hardware or software component useless. The existing system is a military application.

In another aspect of the invention, the device comprises a modular card configured to expand an existing system. The modular card comprises at least one disabling device configured to disable hardware or software components of the existing system.

In embodiments, the at least one disabling device includes an electrostatic discharge device (ESD), electromagnetic pulse device (EMP), a chemical device, a physical device and/or software code. The software code can disarm the disabling device or disable a software component or hardware component of the existing system. The chemical device is an expandable powdered chemical. An actuating device is configured to move along an X-Y coordinate system. The actuating device moves the at least one disabling device. A detection system and communication device is further provided. The detection system is an X-ray sensor, UV sensor, light sensor, infrared sensor, microwave sensor, mechanical switch and/or accelerometer which provides a trigger to activate the at least one disabling device. The modular card is a plug and play device.

In another aspect of the invention, a system comprises an expandable electronic system and at least one modular component configured to expand the expandable electronic system. The at least one modular component includes at least one countermeasure device configured to disable software and/or hardware components of the expandable electronic system upon a triggering event.

In further embodiments, the triggering event is a tampering of the expandable electronic system or an event outside design parameters. The expandable electronic system is housed in a box. The at least one countermeasure device includes an electrostatic discharge device (ESD), electromagnetic pulse device (EMP), a chemical device, a physical device and/or software code. An actuating device is configured to move the least one countermeasure device along an X-Y coordinate system. A detection system includes an X-ray sensor, UV sensor, light sensor, infrared sensor, microwave sensor, mechanical switch and accelerometer in communication with the at least one countermeasure device. The modular card is a plug and play device.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a modular system in accordance with aspects of the invention;

FIG. 2 shows a configuration implementing the system in accordance with aspects of the invention;

FIG. 3 shows a configuration implementing the system in accordance with aspects of the invention; and

FIG. 4 is a flow diagram showing steps implemented in accordance with aspects of the invention.

### DETAILED DESCRIPTION OF EMBODIMENTS OF THE INVENTION

The present invention relates to a system and method of disabling electronic components and more particularly to a system and method of neutralizing electronic and/or software related components of an existing system. In embodiments, the system is a modular component configured to disable electronic and software components. More specifically, in embodiments, the system of the invention is configured to be installed into existing electronic packages (generally referred to as “boxes”). The system is designed to be implemented in a finalized system, making it extremely valuable for deployed systems with finalized hardware that have late receiving anti-tampering requirements. This is especially useful in military applications, as well as other sensitive systems which require protection from nefarious activities. In further embodiments, the system can be designed into the electronic/software system from the ground-up (e.g., not yet developed package) or a system retrofit making it a formidable anti-tampering barrier.

In embodiments, the system and method of the invention is configured to detect tampering of electronic/software systems. This allows the system and method of the invention, without any required user activity, to implement numerous countermeasures thus neutralizing or making inaccessible and/or invalidating a compromised system. An discussed more fully below, the system may be designed based on the architecture of the electronic/software system to be protected, which in implementations, may be a VME card, compact PCI (Peripheral Component Interconnect), PCI or other plug and play circuitry and/or modular devices.

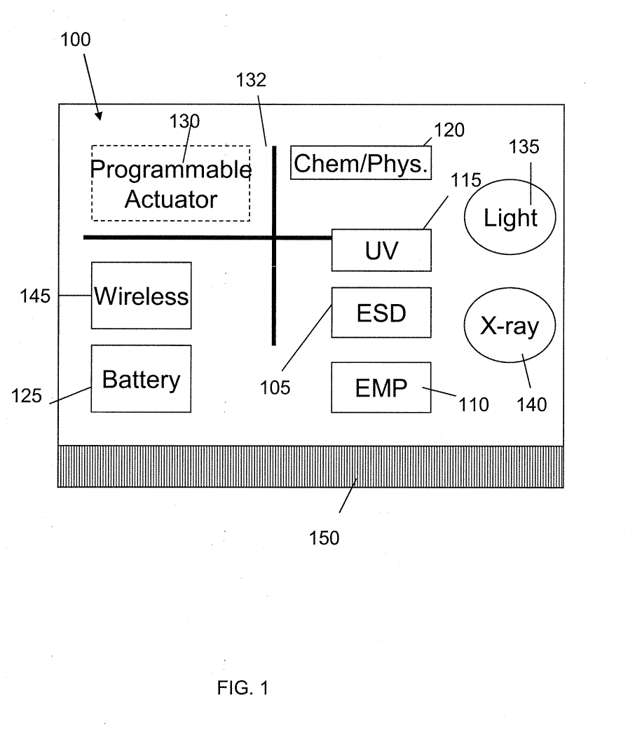

FIG. 1 shows a modular system in accordance with aspects of the invention. In FIG. 1, the system is generally depicted as reference numeral 100. In embodiments, the system 100 is a modular system which may, for example, be a VME card, PCI, compact PCI daughterboard (which covers several components on a motherboard), VME card which PCI daughter card or other modular systems which can be installed in a pre-packaged electronic system, or developed concurrently with the system to be protected. In embodiments, the modular system 100 is plug and play compatible and is constructed to match the form factor (9U, 6U, 3U) of the deliverable box. This configurability provides added barriers to security threats without re-architecting the entire system to be protected.

As briefly discussed above, the system 100 is responsible for neutralizing, invalidating, etc. hardware (electronics) components and/or software components in the event of tamper detection or events occurring outside normal operating conditions. The design further allows a single card (modular) to neutralize various adjacent components using its configurable anti-tampering mechanisms as discussed in more detail below.

Being more specific, the modular system 100 of FIG. 1 shows electrical, physical and chemical mechanisms for rendering other components invalid or useless, thus neutralizing these other components from any useful reverse engineering, etc. In FIG. 1, the system 100 includes an ESD (electric static discharge) device 105, EMP (electromagnetic pulse) device 110, UV (ultra violet) device 115 and/or physical/chemical device 120, or any combination thereof. It should be understood that other devices are also represented herein such as, for example, light detection device and microwave detection device. The ESD 105 device, EMP device 110, UV device 115 and/or physical/chemical device 120 may be powered by an internal battery 125 (e.g., capacitor) or an external power source (e.g., through a VME backplane).

The type, amount and location of the disabling energy, e.g., chemical, electrical, magnetic, etc. is designed into the system 100 based on the circuitry and/or software to be protected and disabled. Accordingly, one of skill in the art, knowing the specific application, would be able to program/design such disabling mechanism to render a specific type of component useless upon a triggering event, e.g., the detection of an opening of the box, scanning of the box with x-rays, etc.

In operation, upon the detection of tampering or any event outside of the design parameters of the system to be protected, the disabling mechanism, e.g., ESD device, can disable the system. For example, the ESD device 105 can discharge an electrostatic charge disabling electronic components such as CMOS devices which contain sensitive information. The battery 125 (or external power source) is configured to contain enough power to complete the mission of disabling the designed circuitry.

In further designs, electromagnetic pulses (high current, high voltage spike) may be emitted to render the electronic circuitry useless. Similarly, a chemical can be discharged to corrode and thus render useless any adjacent or closely placed electronic circuitry. In one example, the chemical may be a reactive powder which is stored in a containment vessel (shown at reference numeral 120). The chemical (reactive powder) is designed to expand upon electrical current and, as it expands, the chemical will be discharged from the containment vessel into the surrounding area. A physical device may be, for example, a temperature inducing device, Freon®, which is discharged into the vicinity of the component to be disabled. A software code embedded into the system may also disable software or hardware of the system to be protected.

Still referring to FIG. 1, the system 100 further includes a programmable actuator 130. The programmable actuator 130 may be programmed to move in the X-Y coordinate system using known activating systems such as magnetic rails, linear actuators, rack and pinion gear systems or other mobility devices generally shown at reference numeral 132. The programmable actuator 130 includes any combination of the devices 105, 110, 115, 120, depending on the application. In this manner, the programmable actuator 130 provides added flexibility to the system 100 by allowing any one or a combination of the devices 105, 110, 115, 120 to be positioned near an electronic and/or software component to be protected. For example, if required, the EMP device 110 can be moved by the programmable actuator 130 near a CMOS device, while the chemical device 120 can be moved by the programmable actuator 130 near a component which is to be disabled by a chemical or physical reaction. This allows the added flexibility in the system by allowing a single system 100 to disable various electronic components in a single box. In embodiments, the programmable actuator 130 may be preprogrammed to correspond with the coordinates for the different circuitry to be protected.

FIG. 1 further shows various detection devices such as a light sensor 135 and an x-ray sensor 140. It should be understand by those of ordinary skill in the art that these sensors are not inclusive of the design. For example, these sensors may equally represent an altitude sensor, accelerometer, mechanical switch, magnetic imaging sensor or any other known sensor or device which can detect intrusion (possible tampering) or an event outside of normal operation conditions.

By way of example, an x-ray sensor may detect scanning x-rays; whereas, a light sensor may detect differing light conditions. In either scenario, upon “scanning” or “opening” a box, the sensors can detect these different conditions, and trigger any or all of the countermeasures (devices 105, 110, 115, 120) to disable the components to be protected. Similarly, an accelerometer may detect vibrations or G-forces or other conditions outside design parameters which, in turn, would trigger the countermeasures. Likewise, a mechanical switch may detect an opening of a cover of the box. The triggering event may also be, for example, an aircraft accident, which can be detected by numerous different detection devices such as, for example, the light sensor, mechanical switch, accelerometer, etc. In the case of the detection of tampering or conditions outside of the design parameters, the detection device would communicate with the countermeasures (devices 105, 110, 115, 120) at which time the system of the invention can be programmed to take proactive or preemptive steps to disable the system(s) to be protected.

The system 100 further comprises a communication device such as a wireless transceiver 145. The wireless transceiver 145 may be used to receive external signals in order to take proactive/preemptive disabling measures. The wireless transceiver 145 may also be used to receive data for disabling the system of the invention for, e.g., maintenance purposes (as discussed below). In the case of a VME card, for example, the communication device may be a backplane 150 of the VME card which is configured to transmit and receive data to and from the system 100. In other embodiments, other connections 150 (other than a backplane) are contemplated by the invention such as, for example, USB ports, Ethernet connections, etc. The react signal may also be received directly from the sensors or detection devices discussed above.

Thus, using these communication mechanisms, the system 100 can receive and send data, e.g., across a bus, from other subsystems. In the case of the VME backplane or other data communication mechanism, the system 100 can also disable software or render it completely useless by sending a “destruct” code, virus, or encryption to the software component. “Destruct” codes are well known in the art and do not need any further explanation herein. In further embodiments, software code can be used to disarm the system 100 for maintenance of other purposes.

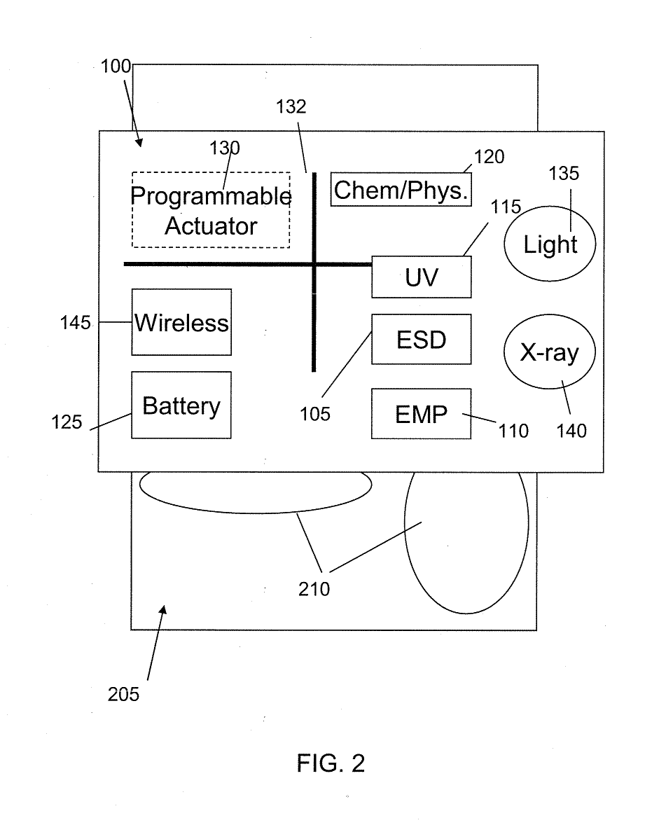

FIG. 2 shows a configuration implementing the system of the invention. In this embodiment, the system 100 is implemented as a daughterboard 100 which covers components 205 of a motherboard 210. The daughterboard 200 includes the functionality and/or components described with reference to FIG. 1. In operation, any of the components on the motherboard 210 may be rendered invalid, disabled, etc. by the countermeasures discussed herein. The daughterboard 100 may also have a direct communication with the motherboard 210 thus rendering software components invalid and/or providing the communication requirements necessary for the specific application including, for example, receiving and sending anti tampering data signals.

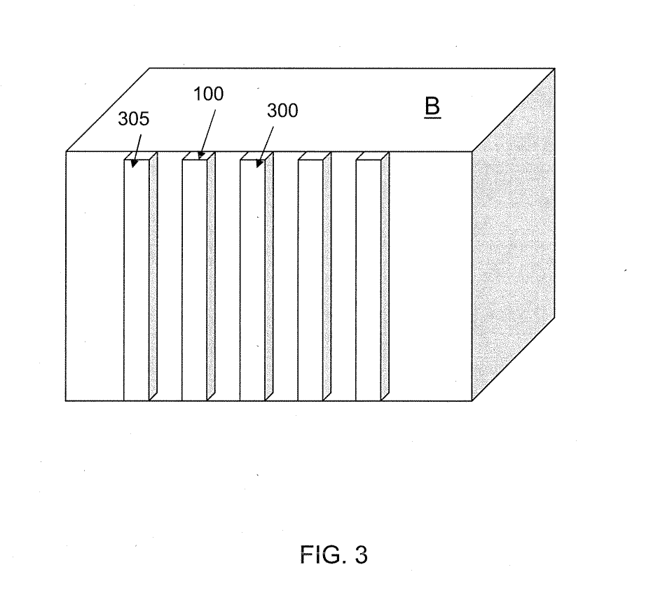

FIG. 3 shows a configuration implementing the system in accordance with aspects of the invention. As shown in FIG. 3, the system 100 is mounted in a box “B”, adjacent other cards 300 or components 305. In the manner described above, the components on the cards 300 may be disabled, invalidated, etc. by the countermeasures of the system. In embodiments, each or some combination of cards 300 may include wireless transceivers 145 which communicate with the system 100 or one another. Any combination of cards 300 may also include the countermeasures (e.g., devices 105, 110, 115, 120).

In embodiments, to reduce costs, the cards 300 do not require any detection sensors, since the system 100 may have the sensor(s) and, upon detection of tampering or events outside design parameters, may transmit such data to any of the cards 300 via the wireless transceiver 145 or other communication devices. Upon receipt of the data, the cards 300 may implement any number of countermeasures discussed herein.

It is also contemplated that the cards 300 may be in other boxes, communicating with the system 100. In this implementation, entire systems or subsystems may be disabled, invalidated, etc. upon detection of tampering, etc. of any one of the systems. This is accomplished via the wireless transceivers (or other communication mechanisms discussed herein).

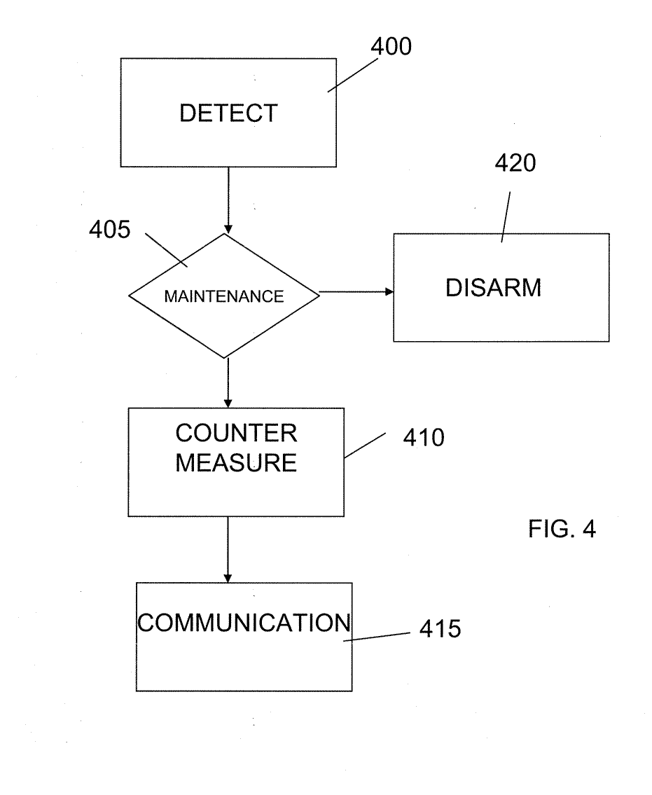

FIG. 4 is a flow chart showing steps in accordance with aspects of the invention. FIG. 4 may equally represent a high-level block diagram of the invention. The steps of FIG. 4 may take the form of an entirely hardware embodiment, an entirely software embodiment or an embodiment containing both hardware and software elements. Software embodiments include but are not limited to firmware, resident software, microcode, etc. Furthermore, the invention can take the form of a computer program product accessible from a computer-usable or computer-readable medium providing program code for use by or in connection with a computer or any instruction execution system. A computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium.

Still referring to FIG. 4, at step 400, the system detects or senses tampering activities or events outside normal operating conditions. At step 405, an optional determination is made as to whether the “box” is undergoing maintenance. If no maintenance is being conducted, at step 410, countermeasures are undertaken to disable, invalidate, etc. one or more components of a system. This may include, for example, determining which components are to be disabled, invalidated, etc., and providing the appropriate countermeasures (e.g., disabling activity). This step may also include powering up the programmable actuator such that one of the countermeasure devices can be moved to an appropriate coordinate to target a specific subsystem, whether it is an electronic component or software component. In an optional process, at step 415, the system may communicate to other systems, subsystems or other disabling devices, for example. This will allow the disabling, invalidating, etc. of more than one system or subsystem over the same or different boxes.

In the maintenance mode, the process continues from step 405 to step 420. At step 420, an authorized person, e.g., maintenance personnel, may disarm the system 100 (e.g., countermeasure) by initiating a secure and/or encrypted message to disarm the system 100. The service message may be provided through the backplane of the VME card or via a wireless transmission, etc. An authorized person, once the system 100 is disabled, may remove the system 100 from the “box”. In the case that the authorized personnel is not the maintenance personnel, the maintenance personnel may not even be aware of the system 100 (e.g., countermeasures) thus adding an additional layer of security.

While the invention has been described in terms of embodiments, those skilled in the art will recognize that the invention can be practiced with modifications and in the spirit and scope of the appended claims.

What is claimed:

1. A device, comprising:
a modular component configured to be compatible with an existing system; and
at least one countermeasure component associated with the modular component and configured to disable a component of the existing system.

2. The device of claim 1, wherein the at least one countermeasure component includes at least one of an electrostatic discharge device (ESD), electromagnetic pulse device (EMP), a chemical device, a physical device and software code.

3. The device of claim 2, wherein the software code is encryption software to disarm the at least one countermeasure component or disable a software component or hardware component of the existing system.

4. The device of claim 2, wherein the chemical device is an expandable powdered chemical.

5. The device of claim 1, further comprising an actuating device configured to move along an X-Y coordinate system of the modular component.

6. The device of claim 5, wherein the actuating device is programmable.

7. The device of claim 5, wherein the actuating device includes one of a screw type device, rack and pinion gear, and magnetic component to move the actuating device along the X-Y coordinate system.

8. The device of claim 5, wherein the at least one countermeasure component is provided on the actuating device.

9. The device of claim 1, further comprising a detection system.

10. The device of claim 9, wherein the detection system is at least one of an X-ray sensor, UV sensor, light sensor, infrared sensor, microwave sensor, mechanical switch and accelerometer.

11. The device of claim 1, further comprising a wireless device for receiving data signals.

12. The device of claim 11, wherein the wireless device transmits data signals.

13. The device of claim 1, wherein the modular device is one of a VME card, daughtercard, power PCI (Peripheral Component Interconnect) and PCI.

14. The device of claim 1, wherein the modular component is a plug and play device.

15. The device of claim 1, wherein the at least one countermeasure component is configured to render a hardware or software component useless.

16. The device of claim 1, wherein the existing system is a military application.

17. A device comprising a modular card configured to expand an existing system, the modular card comprising at least one device configured to disable hardware or software component of the existing system.

18. The device of claim 17, wherein the at least one device includes at least one of an electrostatic discharge device (ESD), electromagnetic pulse device (EMP), a chemical device, a physical device and software code.

19. The device of claim 18, wherein the chemical device is an expandable powdered chemical.

20. The device of claim 17, further comprising an actuating device configured to move along an X-Y coordinate system, the actuating device moving the at least one device.

21. The device of claim 17, further comprising a detection system which is at least one of X-ray sensor, UV sensor, light sensor, infrared sensor, microwave sensor, mechanical switch and accelerometer which provides a trigger to activate the at least one device.

22. The device of claim 17, further comprising a communication device.

23. The device of claim 17, wherein the modular card is a plug and play device.

24. A system comprising:
an expandable electronic system; and
at least one modular component configured to expand the expandable electronic system, the at least one modular component including at least one countermeasure device configured to disable at least one of software and hardware components of the expandable electronic system upon a triggering event.

25. The system of claim 24, wherein the triggering event is a tampering of the expandable electronic system or an event outside design parameters.

26. The system of claim 24, wherein the expandable electronic system is housed in a box.

27. The device of claim 24, wherein the at least one countermeasure device includes at least one of an electrostatic discharge device (ESD), electromagnetic pulse device (EMP), a chemical device, a physical device and software code.

28. The device of claim 24, further comprising an actuating device configured to move the least one countermeasure device along an X-Y coordinate system.

29. The device of claim 24, further comprising a detection system which is at least one of X-ray sensor, UV sensor, light sensor, infrared sensor, microwave sensor, mechanical switch and accelerometer in communication with the at least one countermeasure device.

30. The device of claim 24, further comprising a communication device.

31. The device of claim 24, wherein the modular card is a plug and play device.
